(19) United States
(12) Patent Application Publication
(10) Pub. No.: US 2024/0222730 A1
(43) Pub. Date: Jul. 4, 2024

(54) Modular rechargeable battery pack for a hand-held power tool, hand-held power tool and repair method

(71) Applicant: Hilti Aktiengesellschaft, Schaan (LI)

(72) Inventor: Kevin KUHLMANN, Kaufering (DE)

(21) Appl. No.: 18/558,235

(22) PCT Filed: May 5, 2022
(86) PCT No.: PCT/EP2022/062122

§ 371 Date: Oct. 31, 2023

(30) Foreign Application Priority Data
May 17, 2021 (EP) 21174112.9

(51) Int. Cl. H01M 10/48; H01M 50/247; H01M 50/258; H01M 50/51; H01M 50/517

(52) U.S. Cl. CPC H01M 10/486; H01M 10/482; H01M 10/488; H01M 50/247; H01M 50/258; H01M 50/51; H01M 50/517; H01M 2220/30

(57) ABSTRACT

A modular rechargeable battery unit (100) for a hand-held power tool (1), having an electronics module (110) and at least one cell module (120), wherein the electronics module (110) is set up to monitor a state of the at least one cell module (120) depending on at least one measured value (U, I, T), wherein the at least one cell module (120) comprises a holding frame (121) and a plurality of individual cells (122) held by the holding frame (121), wherein the individual cells (122) are electrically connected to one another (123) in the holding frame (121) to provide a predetermined output voltage, and wherein the electronics module (110) and the at least one cell module (120) can be connected to one another exclusively via releasable mechanical (130) and electrical (132) connections.

### FIELD OF THE INVENTION

The present invention relates to a modular rechargeable battery unit for a hand-held power tool, to a hand-held power tool having a corresponding rechargeable battery unit and to a repair method for such a rechargeable battery unit.

### BACKGROUND

Hand-held power tools are often operated using rechargeable battery units. Rechargeable battery units progressively lose performance over time through aging. Aging in this case particularly affects the individual galvanic cells. In addition to the individual cells, rechargeable battery units often have other components, such as electronics systems or a housing, which are less or hardly affected by aging. Therefore, these components can still continue to be used when the cells of the rechargeable battery pack are already unusable.

### SUMMARY OF THE INVENTION

However, known rechargeable battery units are integrated in such a way that the components cannot be separated from one another without being damaged, for example via welded or soldered connections.

Against this background, an object of the present invention is to propose an improved rechargeable battery unit for a hand-held power tool.

A first aspect proposes a modular rechargeable battery unit for a hand-held power tool. The modular rechargeable battery unit comprises an electronics module and at least one cell module. The electronics module is set up to monitor a state of the at least one cell module depending on at least one measured value. The at least one cell module comprises a holding frame and a plurality of individual cells held by the holding frame, wherein the individual cells are electrically connected to one another in the holding frame to provide a predetermined output voltage. The electronics module and the at least one cell module can be connected to one another exclusively via releasable mechanical and electrical connections.

This modular rechargeable battery unit (hereinafter also referred to as “battery unit” for short) has the advantage that the individual modules can be replaced independently of one another. In the event of a defect, therefore, the entire rechargeable battery unit does not have to be replaced, but only the defective module. In addition, the rechargeable battery unit can be repaired by disassembling it into the individual modules, which makes the site of the defect accessible.

The rechargeable battery unit is set up, in particular, to operate a hand-held power tool that is operated with an operating voltage in the range of 9 V-72 V, preferably between 12 V-36 V.

The output voltage is achieved, for example, by individual cells connected in series in the cell module. For example, when fully charged, a single lithium-ion cell has an output voltage (terminal voltage) of about 3.6 V. If two of these cells are connected in series, the output voltage doubles to about 7.2 V. Besides lithium-ion cells, other galvanic cells can also be used, such as nickel-cadmium, nickel-metal hydride or lead cells, which can then have different output voltages.

The electronics module comprises, for example, an integrated circuit, such as an ASIC (application-specific integrated circuit), a PLC (programmable logic controller), or the like. The integrated circuit is operated, for example, by a voltage tapped off at the coupled cell module. The integrated circuit is set up to monitor the state of the cell module. The state can in this case include information about a current remaining capacity (state of charge), a current charging and/or discharge current, a current terminal voltage, a current individual cell voltage of each individual cell of the at least one cell module, and a current temperature of one or more cells of the at least one cell module.

To monitor the state, the electronics module can comprise a number of sensors and/or be electrically connected to sensors that are part of the cell module. The electronics module preferably comprises one or more voltmeters, one or more ammeters and is connected to at least one temperature sensor.

The electronics unit can be set up to control a charging or discharge current of the at least one cell unit. In this case, the electronics unit can interact, in particular, with elements of the hand-held power tool and/or a charging device.

In embodiments, the electronics module is set up to provide electrical contacts for electrically connecting the at least one cell module to the hand-held power tool.

In this embodiment, a current flows from the cell module to the hand-held power tool via at least one current line arranged in the electronics module. It is also possible to say that one pole or both poles of the at least one cell module are looped through the electronics module. In this embodiment, the electronics module can be set up, for example, to control a discharge current of the at least one cell unit depending on a corresponding signal from the hand-held power tool and/or the state of the cell module. The electronics module can also be set up to interrupt a current flow from the cell module to the hand-held power tool. The electronics module comprises, for example, two cell-module-side contacts for making contact with two corresponding contacts arranged on the cell module, to which contacts the output voltage of the cell module is applied. Furthermore, the electronics module comprises two hand-held-power-tool-side contacts for making contact with two corresponding contacts arranged on the hand-held power tool, at which contacts the output voltage is provided.

The cell module comprises an arrangement of multiple individual cells that are hard-wired together in the cell module in order to provide the output voltage. The individual cells can be partially connected in the cell module both in an electrical parallel circuit and in an electrical series circuit. An electrical parallel circuit is suitable for increasing the capacity of the cell module without increasing the output voltage in the process. The holding frame of the cell module gives the arrangement of the individual cells mechanical stability. The individual cells are preferably fastened in the cell module using a non-releasable connection. In embodiments, provision may be made for the individual cells to be held by the cell module in a releasable manner. The holding frame of the cell module is made, for example, from plastic, from a composite material, in particular comprising carbon fiber, glass fiber and/or aramid fiber, from metal and/or from a combination of the aforementioned materials.

A single cell is understood to mean, in particular, a galvanic cell that provides exactly two electrical poles. This means that an individual cell in particular does not consist of two or more units which each form a galvanic cell on its own.

The electronics module and the at least one cell module can preferably be connected to one another by means of latching, snap-fit, plug-in and/or screw connections in a force-fitting manner, preferably in a form-fitting manner. These connections can be released so that the electronics module and the at least one cell module can be transferred from a coupled state to a disassembled state without the electronics module or the cell module being damaged in the process.

Electrical connections between the electronics module and the cell module are preferably produced by means of plug contacts, but spring contacts can also be used, particularly in the case of pure signal paths over which only a minimal current flows.

According to one embodiment of the modular rechargeable battery unit, the electronics module is set up to detect at least one voltage value and/or a current value and to monitor the state of the at least one cell module depending on the detected voltage value and/or current value.

In this embodiment, the electronics module is advantageously set up to monitor a state of charge of the at least one cell module. The electronics module can thus prevent the cell module from being discharged too much, which could damage or even destroy the individual cells in the cell module.

According to a further embodiment of the modular rechargeable battery unit, the electronics module comprises at least one temperature sensor for detecting at least one temperature value of the at least one cell module and the electronics module is set up to monitor the state of the cell module depending on the detected temperature value.

The detected temperature value relates, in particular, to a temperature on the surface of at least one individual cell. The temperature value is representative of a temperature present in the individual cell and of an average temperature in the cell module. It can be assumed, for example, that further individual cells have essentially the same temperature.

Depending on the number of individual cells in the cell module, it is possible to provide several temperature sensors that are set up to detect a respective temperature value of different individual cells.

The temperature has a significant influence on the individual cells. On the one hand, the mobility of the charge carriers in the individual cell is increased at higher temperatures, as a result of which the internal resistance of the individual cell decreases. On the other hand, as the temperature increases, a chemical reaction rate of undesirable chemical reactions, such as corrosion, also increases in the individual cell, which causes the cell to age more quickly. In addition, if an upper limit temperature is exceeded, the individual cell can be permanently damaged or destroyed; in the worst case, the individual cell can even ignite and/or decompose. It is therefore advantageous for the electronics module to monitor the temperature. For example, when the temperature becomes too high, the electronics module can reduce a charging or discharge current for the cell module so as to increase the life of the cell module.

According to a further embodiment of the modular rechargeable battery unit, the temperature sensor is held in direct contact with an individual cell of the at least one cell module by a spring element.

In this embodiment, the temperature sensor is not permanently connected to the cell module, but can be separated from the cell module using the electronics module without the temperature sensor being damaged in the process.

In embodiments, provision may be made for the temperature sensor to be integrated into the cell module and to be able to be connected to the electronics module by means of a plug connector or the like.

According to a further embodiment of the modular rechargeable battery unit, the electronics module is set up to detect an individual cell voltage of each individual cell of the at least one cell module, wherein an associated electrical line is provided for each individual cell.

This embodiment advantageously makes it possible to ascertain whether particular individual cells of the cell module are defective and/or limit the power of the cell module. In an electrical series circuit, the current flows through each of the individual cells connected in series, which is why it is problematic if only one of the cells has an increased internal resistance, for example, since this limits the overall current flow and the affected individual cell is also heated particularly strongly.

The voltage of a respective individual cell is tapped, in particular, via an associated line and a spring contact.

According to a further embodiment of the modular rechargeable battery, the individual cells in the at least one cell module are connected to one another in an electrical series circuit and/or electrical parallel circuit, with the result that the cell module has the predetermined output voltage and a predetermined charge capacity.

According to a further embodiment of the modular rechargeable battery unit, it comprises two or more cell modules that can be coupled to one another in a releasable manner.

This embodiment has the advantage that if one of the cell modules is defective or has insufficient power, only this one needs to be replaced, while the other cell module can continue to be used.

In this embodiment, the rechargeable battery unit comprises at least the electronics module and two cell modules.

The cell modules are preferably first coupled to one another and then the coupled cell modules are coupled to the electronics module.

In embodiments, provision may be made for the cell modules to be able to be coupled individually to the electronics module.

According to a further embodiment of the modular rechargeable battery unit, the two or more cell modules are connected to one another in an electrical series circuit, with the result that the output voltage of the rechargeable battery unit corresponds to the sum of the output voltage provided by the two or more cell modules.

This embodiment has the advantage that, especially for hand-held power tools that are designed for a high operating voltage, such as 24 V, 36 V, 48 V or up to 72 V, for example, for which a large number of individual cells connected in series is necessary, the cell modules can still be manufactured with a smaller number of individual cells.

According to a further embodiment of the modular rechargeable battery unit, the two or more cell modules can be connected to one another by means of latching, snap-fit, plug-in and/or screw connections, in particular can be connected to one another in a form-fitting and/or force-fitting manner.

A second aspect proposes a hand-held power tool having a modular rechargeable battery unit according to the first aspect.

The hand-held power tool is, for example, in the form of a drill, a percussion drill, a hammer drill, a handheld circular saw, a jigsaw, a foxtail saw, an angle grinder, an agitator or the like.

A third aspect proposes a repair method for a modular rechargeable battery unit. The modular rechargeable battery unit comprises an electronics module and at least one cell module that can be connected to one another exclusively via releasable mechanical and electrical connections. The repair method comprises the steps of:
ascertaining a state of the at least one cell module, and
replacing the at least one cell module depending on the ascertained state with a replacement cell module whose state is better than the ascertained state.

The rechargeable battery unit is designed, in particular, as described with reference to the first aspect.

The rechargeable battery unit can advantageously be repaired without the electronics unit or the at least one cell module being damaged. In most cases, the electronics module of a battery unit is still functional if the cell module is already showing clear signs of aging, which is why the cell module usually has to be replaced.

According to one embodiment of the repair method, the replacement comprises dismantling the modular rechargeable battery unit into the electronics module and the at least one cell module by releasing the releasable mechanical and electrical connections, and assembling the modular rechargeable battery unit with the electronics module and the replacement cell module by closing the releasable mechanical and electrical connections.

In this embodiment, the electronics unit, in particular, continues to be used. This is often possible because the electronics unit is not subject to any aging comparable to that of the cell modules.

According to a further embodiment of the repair method, the replacement cell module is a brand-new cell module.

According to a further embodiment of the repair method, the modular rechargeable battery unit has two or more cell modules that can be coupled to one another in a releasable manner, with only exactly one of the cell modules being replaced and/or with at least one of the cell modules not being replaced.

In this embodiment, at least one cell module, in particular the cell module with the best performance, continues to be used. A number of exchanged cell modules can thus be reduced.

According to a further embodiment of the repair method, ascertainment of the state of a respective cell module comprises ascertaining a charge capacity, an internal resistance, a number of charging cycles and/or a discharge curve of the respective cell module.

### BRIEF DESCRIPTION OF THE FIGURES

The following description explains the invention with reference to exemplary embodiments and figures, in which:

FIG. 1 shows a schematic view of a modular rechargeable battery unit;

FIG. 2 shows a schematic view of two cell modules;

FIG. 3 shows a schematic topology of an electrical interconnection of a modular rechargeable battery unit for a hand-held power tool;

FIG. 4 shows a schematic flow diagram of a repair method for a modular rechargeable battery unit;

FIG. 5 shows a schematic flow diagram of a further repair method for a modular rechargeable battery unit; and

FIG. 6 shows a schematic view of a hand-held power tool.

Identical or functionally identical elements are indicated by the same reference signs in the figures, unless stated otherwise.

### DETAILED DESCRIPTION

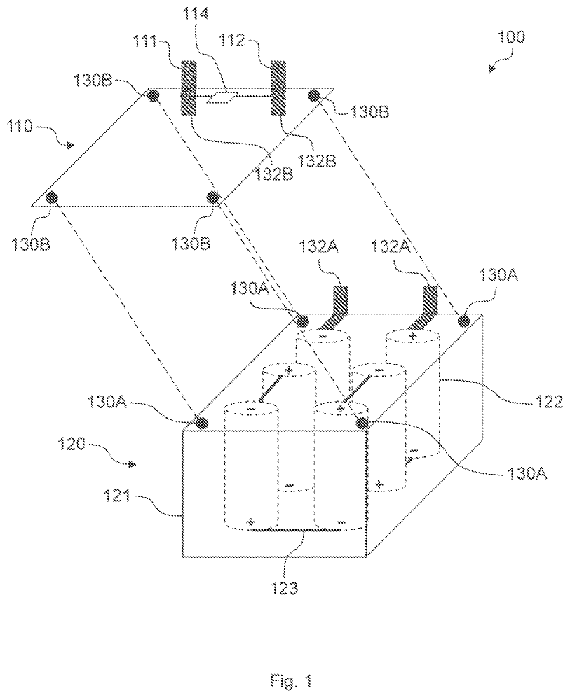

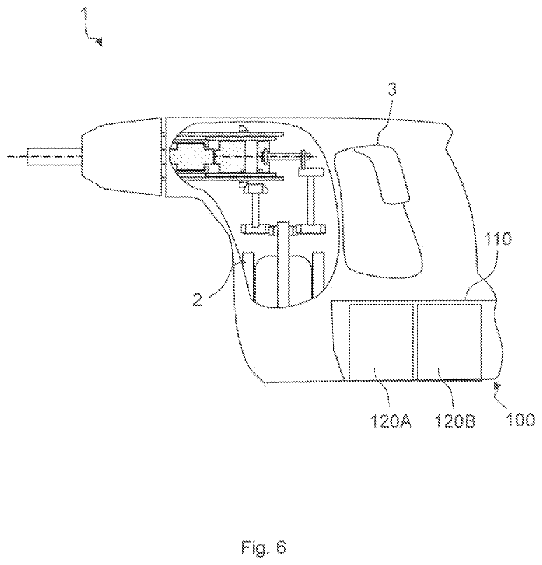

FIG. 1 shows a schematic view of a modular rechargeable battery unit 100 for a hand-held power tool 1 (see FIG. 6). The modular rechargeable battery unit 100 comprises an electronics module 110 and a cell module 120. The cell module 120 comprises a holding frame 121 that is designed to hold a number of individual cells 122. The individual cells 122 arranged in the holding frame 121 are hard-wired to one another via electrical connections 123, such that the cell module 120 has a specific output voltage and a specific total capacity. The output voltage and the total capacity depend on the type of the individual cells 122, in particular the individual cell voltage and the individual capacities thereof, and the type of wiring of the individual cells 122 in the holding frame 121. The electrical connections 123 between the individual cells 122 can be integrated into the holding frame 121, for example in the form of holding plates, or they can be formed separately from the holding frame, for example in the form of individual wires or pieces of cable. If the individual cells 122 are electrically connected in series, the output voltage corresponds to the sum of the individual cell voltages. In an electrical parallel circuit, the total capacity corresponds to the sum of the individual cell capacities. The individual cells 122 can be connected in parallel in groups in the cell module 120, for example, and the groups can be connected in series.

The cell module 120 comprises releasable mechanical connectors 130A and releasable electrical connectors 132A. For example, the mechanical connectors 130A are threads suitable for screwing in a corresponding screw, and the electrical connectors 132A are plug contacts that can be connected to corresponding sockets.

The electronics module 110 has connectors 130B, 132B corresponding to the releasable mechanical 130A and electrical 132A connectors of the cell module 120. In this example, these are, for example, screws 130B and sockets 132B. The electronics module 110 is set up to monitor a state of the cell module 120 depending on at least one measured value U, I, T (see FIG. 3). For this purpose, the electronics module 110 comprises, in particular, a corresponding measuring device 114 that is designed, for example, as a voltage measuring device and is set up to detect an output voltage of the cell module 120. In embodiments, the measuring device 114 can be set up to detect an individual cell voltage of each individual cell 122 of the cell module 120 (not shown).

In this example, the electronics module 110 also comprises two electrical contacts 111, 112 for making contact with corresponding electrical contacts of hand-held power tool 1. In particular, the output voltage of the cell module 120 is provided at the contacts 111, 112. In this example, a current for driving an electric motor 2 (see FIG. 6) of the hand-held power tool 1 flows from the electrical connectors 132A via the electrical connectors 132B and the contacts 111, 112 to the electric motor 2.

The releasable mechanical 130A, 130B and electrical 132A, 132B connectors allow the electronics module 110 and the cell module 120 to be disconnected from one another and reconnected without damaging either. In other words, the modular rechargeable battery unit 100 can be disassembled and reassembled.

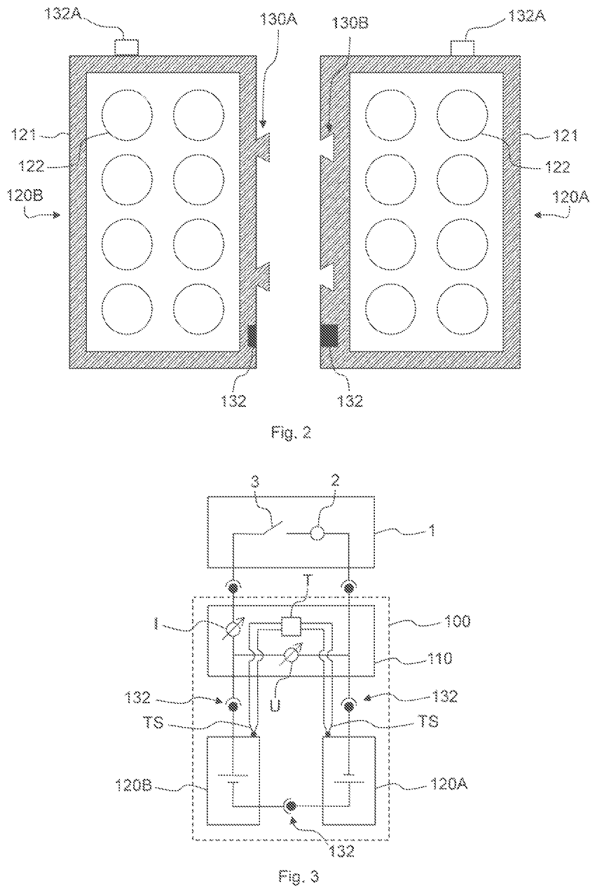

The rechargeable battery unit 100 is not limited to just one cell module 120, as explained below with reference to FIG. 2. FIG. 2 shows a schematic view of two cell modules 120A, 120B, each of which has a holding frame 121 and a plurality of individual cells 122. The cell modules are each equipped with releasable mechanical connectors 130A (see FIG. 1), these not being shown in FIG. 2 for the sake of clarity. The two cell modules 120A, 120B are set up to be connected and separated again via releasable mechanical 130A, 130B and electrical 132 connections. The cell modules 120A, 120B are designed in this case, in particular, for joint use in a modular rechargeable battery unit 100 in combination with an electronics module 110 (see FIG. 1).

For this purpose, each of the cell modules 120A, 120B has a releasable electrical connector 132A, via which an electrical connection to the electronics module 110 and/or to the hand-held power tool 100 can be produced. In addition, each of the cell modules 120A, 120B has an electrical contact 132 for making contact with the respective other cell module 120A, 120B. If the cell modules 120A, 120B are coupled to one another by means of the releasable mechanical connectors 130A, 130B, which in this example takes place in a form-fitting manner by means of a dovetail connector incorporated into the respective holding frame 121, the electrical contacts 132 are contacted at the same time. As an alternative to this, a separate plug contact can also be provided.

By making contact with the electrical contacts 132, the two cell modules 120A, 120B are electrically connected in series, with the output voltage being provided at both the electrical connectors 132A (see also FIG. 3 below in this regard). The cell modules 120A, 120B that are releasably connected to one another in this way can then be connected to a corresponding electronics module 110 in order to form a rechargeable battery unit 100.

FIG. 3 shows a schematic topology of an electrical interconnection of a modular rechargeable battery unit 100 for a hand-held power tool 1. FIG. 3 here represents the case in which two cell modules 120A, 120B are connected in series with one another. The electronics module 110 is set up to record various measured values I (current), U (voltage), T (temperature) of the cell modules 120A, 120B. In particular, the electronics module 110 has two temperature sensors TS, each one of which is assigned to one of the cell modules 120A, 120B. Not shown, but also possible, is the detection of individual cell voltages for each individual cell 122 (see FIG. 1 or 2) of the cell modules 120A, 120B.

It can be seen in FIG. 3 that all electrical connections 132 are produced via releasable socket/plug combinations or the like. The circuit is closed via a main switch 3 in the hand-held power tool 1, such that a current provided by the modular rechargeable battery unit 100 can flow through the motor 2 of the hand-held power tool 1.

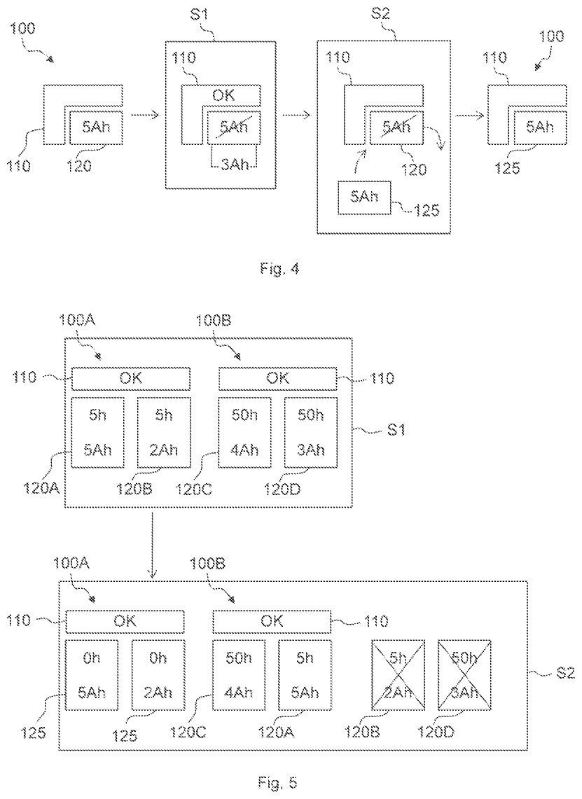

FIG. 4 shows a schematic flow diagram of a repair method for a modular rechargeable battery unit 100, for example that shown in FIG. 1. The rechargeable battery unit 100 is intended for use in a rechargeable-battery-operated hand-held power tool 1 (see FIG. 3 or 6).

The starting point is a modular rechargeable battery unit 100 that comprises an electronics module 110 and a cell module 120. For example, nominally, the cell module 120 should have a capacity of 5 Ah (ampere hours).

In a first step S1 of the repair method, a state of the cell module 120 is ascertained. In this example, for example, an actual capacity of only 3 Ah is ascertained. This may be the case, for example, due to aging of the cell module 120 after some use. The state of the electronics module 110 is also ascertained, with no malfunctions or the like being determined. The electronics module is accordingly marked with “OK”. For the first step, the modular rechargeable battery unit 100 does not necessarily have to be disassembled.

In a second step S2 of the repair method, the cell module 120 is exchanged for a replacement cell module 125. The replacement cell module 125 is, for example, a brand-new cell module. The replacement cell module 125 has the full 5 Ah capacity. For the replacement, the old cell module 120 is disassembled from the electronics module 110 by disconnecting the releasable mechanical 130A, 130B (see FIG. 1) and electrical 132A, 132B connections, and then the replacement cell module 125 is mounted by means of the connections 130A, 130B, 132A, 132B to the electronics module 110.

The repaired rechargeable battery unit 100 then has a performance comparable to a completely new battery unit.

FIG. 5 shows a schematic flow diagram of a further repair method for modular rechargeable battery units 100A and 100B. The rechargeable battery units 100A, 100B are each intended for use in a rechargeable-battery-operated hand-held power tool 1 (see FIG. 3 or 6). In this example, the rechargeable battery units 100 each have an electronics module 110 and two cell modules 120A, 120B, 120C, 120D. The structure of an individual rechargeable battery unit 100A, 100B can be explained, for example, with reference to FIG. 2 or 3.

In the first method step S1, the state of both rechargeable battery units 100A, 100B is ascertained by ascertaining the state of each module. It should be noted that, in embodiments, only the state of the cell modules 120 can be ascertained. In this example, ascertaining the state comprises a functional test of the respective electronics module 110, with both electronics modules 110 being good (“OK”), and an operating time and an actual charge capacity of each cell module 120A, 120B, 120C, 120D being ascertained. The cell module 120A has an operating time of 5 hours and an actual capacity of 5 Ah. The cell module 120B has an operating time of 5 hours and an actual capacity of 2 Ah. The cell module 120C has an operating time of 50 hours and an actual capacity of 4 Ah. The cell module 120D has an operating time of 5 hours and an actual capacity of 3 Ah.

In the second method step S2, the cell modules 120A, 120B, 120C, 120D are at least partially replaced. In this example, the rechargeable battery unit 100A is fully equipped with new replacement cell modules 125. In the rechargeable battery unit pack 110B, the weaker cell module 120D is replaced with the cell module 120A that has been detached from the rechargeable battery unit 110A.

The two weakest cell modules 120B, 120D are recycled since they no longer have sufficient electrical power.

In the manner described, with a plurality of modular rechargeable battery units 100A, 100B, each having a plurality of cell modules 120, it is possible to ascertain pairs of cell modules 120 whose condition is still OK for further use and which have a similar state. These pairs can then be used in repaired rechargeable battery units 100. Cell modules 120 that are in a poor state can be recycled and are replaced with other cell modules 120. The state of a repaired rechargeable battery unit 100 is therefore always better than the state of the rechargeable battery unit 100 before the repair.

FIG. 6 shows a schematic view of a rechargeable-battery-operated hand-held power tool 1. The tool is, for example, a hammer drill. The hammer drill 1 comprises an electric motor 2 that is supplied with power by a modular rechargeable battery unit 100, for example that explained with reference to FIG. 2 or 3. A main switch 3 in this case controls, for example, the power that is drawn from the rechargeable battery unit 100. In this example, the rechargeable battery unit 100 comprises an electronics module 110 and two cell modules 120A, 120B. If the performance of the rechargeable battery unit 100 decreases, then it can be repaired, for example, using the repair method explained with reference to FIG. 4 or 5 by replacing one or both cell modules 120A, 120B.

### LIST OF REFERENCE SIGNS

1 Hand-held power tool
2 Electric motor
3 Switch
100 Modular rechargeable battery unit
100A Modular rechargeable battery unit
100B Modular rechargeable battery unit
110 Electronics module
111 Electrical contact
112 Electrical contact
114 Measuring device
120 Cell module
120A Cell module
120B Cell module
120C Cell module
120D Cell module
121 Holding frame
122 Individual cell
123 Electrical connection
125 Replacement cell module
130 Releasable mechanical connection
130A Releasable mechanical connection
130B Releasable mechanical connection
132 Releasable electrical connection
132A Releasable electrical connection
132B Releasable electrical connection
I Current
S1 Method step
S2 Method step
T Temperature
TS Temperature sensor
U Voltage

What is claimed is:

1-15. (canceled)

16. A modular rechargeable battery unit for a hand-held power tool, the modular rechargeable battery unit comprising:
an electronics module; and
at least one cell module,
the electronics module set up to monitor a state of the at least one cell module depending on at least one measured value, the at least one cell module including a holding frame and a plurality of individual cells held by the holding frame, the individual cells electrically connected to one another in the holding frame to provide a predetermined output voltage, and the electronics module and the at least one cell module connectable to one another exclusively via releasable mechanical and electrical connections.

17. The modular rechargeable battery unit as recited in claim 16 wherein electronics module is set up to detect at least one voltage value or a current value and to monitor the state of the at least one cell module depending on the detected voltage value or current value.

18. The modular rechargeable battery unit as recited in claim 16 wherein the electronics module includes at least one temperature sensor for detecting at least one temperature value of the at least one cell module and wherein the electronics module is set up to monitor the state of the cell module depending on the detected temperature value.

19. The modular rechargeable battery unit as recited in claim 18 wherein the temperature sensor is held in direct contact with an individual cell of the at least one cell module by a spring.

20. The modular rechargeable battery unit as recited in claim 16 wherein the electronics module is set up to detect an individual cell voltage of each individual cell of the at least one cell module, wherein an associated electrical line is provided for each individual cell.

21. The modular rechargeable battery unit as recited in claim 16 wherein the individual cells in the at least one cell module are connected to one another in an electrical series circuit or electrical parallel circuit, with the result that the cell module has the predetermined output voltage and a predetermined charge capacity.

22. The modular rechargeable battery unit as recited in claim 16 wherein the at least one cell module includes two or more cell modules couplable to one another in a releasable manner.

23. The modular rechargeable battery unit as recited in claim 22 wherein the two or more cell modules are connected to one another in an electrical series circuit, with the result that the output voltage of the rechargeable battery unit corresponds to a sum of the output voltage provided by the two or more cell modules.

24. The modular rechargeable battery unit as recited in claim 22 wherein the two or more cell modules are connectable to one another via latching, snap-fit, plug-in or screw connections.

25. The modular rechargeable battery unit as recited in claim 24 wherein the two or more cell modules are connectable to one another in a form-fitting or force-fitting manner.

26. A hand-held power tool comprising the modular rechargeable battery unit as recited in claim 16.

27. A repair method for a modular rechargeable battery unit having an electronics module and at least one cell module connectable to one another exclusively via releasable mechanical and electrical connections, the repair method comprising the steps of:
ascertaining a state of the at least one cell module; and
replacing the at least one cell module depending on the ascertained state with a replacement cell module whose state is better than the ascertained state.

28. The repair method as recited in claim 27 wherein the replacing step includes:
dismantling the modular rechargeable battery unit into the electronics module and the at least one cell module by releasing the releasable mechanical and electrical connections, and
assembling the modular rechargeable battery unit with the electronics module and the replacement cell module by closing the releasable mechanical and electrical connections.

29. The repair method as recited in claim 27 wherein the replacement cell module is a brand-new cell module.

30. The repair method as recited in claim 27 wherein at least one cell module has two or more cell modules couplable to one another in a releasable manner, with only exactly one of the cell modules being replaced or with at least one of the cell modules not being replaced.

31. The repair method as recited in claim 27 wherein the ascertaining step includes ascertaining a charge capacity, an internal resistance, a number of charging cycles or a discharge curve.
